(19) United States
(12) Patent Application Publication
(10) Pub. No.: US 2021/0330114 A1
(43) Pub. Date: Oct. 28, 2021

(54) PORTABLE COFFEE DRIP-BREWER

(71) Applicant: GF Factory Co., Ltd., Bucheon-si (KR)

(72) Inventor: Won Jae LEE, Incheon (KR)

(73) Assignee: GF Factory Co., Ltd., Bucheon-si (KR)

(21) Appl. No.: 17/149,738

(22) Filed: Jan. 15, 2021

(30) Foreign Application Priority Data
Apr. 22, 2020 (KR) 10-2020-0048514

(51) Int. Cl. A47J 31/02; A47J 31/06; A47J 31/00

(52) U.S. Cl. CPC A47J 31/02; A47J 31/005; A47J 31/002; A47J 31/0626

(57) ABSTRACT

An object of the present invention is to provide a coffee drip-brewer capable of extracting drip coffee anywhere while carrying the coffee drip-brewer in a bag or the like. To this end, the coffee drip-brewer of the present invention, as a coffee drip-brewer for extracting coffee by pouring water into coffee powder, includes a water container configured to contain the water and have one or more drain portions formed on a lower end thereof; a coffee powder container provided detachably at a lower portion of the water container and configured to contain the coffee powder and form a moving path of the water drained by the drain portions; and a coffee receiving container provided detachably at a lower portion of the coffee powder container and configured to pass through the coffee powder and receive the extracted coffee.

### TECHNICAL FIELD

The present invention relates to coffee.

### BACKGROUND ART

In general, coffee is a fruit of a coffee tree and is widely used as a raw material for tea due to the unique aroma. This coffee is made into drinking coffee that can be drunk through a coffee maker after roasting and grinding.

For example, the drinking coffee may be largely classified into drip coffee to be extracted by pouring water into coffee powder, espresso to be extracted by adding water of high temperature and high pressure to coffee powder, and the like.

Here, an espresso machine or the like is used as a coffee maker to extract the espresso, and a drip-brewer or the like is used as a coffee maker to extract the drip-coffee. In particular, the drip-brewer is cheaper than the espresso machine and is universally used in the home.

However, since an existing drip-brewer provides a technical configuration that requires the use of electricity using a plug, there is a problem that the drip-brewer is unavailable in places without an outlet, and the like, and even if the problem of the plug is not considered, there is a problem that since a main body, a water container, a coffee powder container, an extracted coffee receiving container, and the like of the drip-brewer are all separated from each other, it is difficult to be carried.

### DISCLOSURE

### Technical Problem

An object of the present invention is to provide a coffee drip-brewer capable of extracting drip coffee anywhere while carrying the coffee drip-brewer in a bag or the like.

### Technical Solution

To achieve the object, according to an embodiment of the present invention, a coffee drip-brewer, as a coffee drip-brewer for extracting coffee by pouring water into coffee powder, includes a water container configured to contain the water and have one or more drain portions formed on a lower end thereof; a coffee powder container provided detachably at a lower portion of the water container and configured to contain the coffee powder and form a moving path of the water drained by the drain portions; and a coffee receiving container provided detachably at a lower portion of the coffee powder container and configured to pass through the coffee powder and receive the extracted coffee.

The coffee powder container may include a filter receiver provided detachably at an upper portion of the coffee receiving container, seated with a filter for filtering the coffee powder while the coffee is extracted, and having one or more through holes; and a coffee powder container provided detachably at an upper portion of the filter receiver and containing the coffee powder with the filter receiver.

A lower portion of the water container may be detachably provided at the upper portion of the coffee powder container by a first detachable portion, a lower portion of the coffee powder container may be detachably provided on the filter receiver by a second detachable portion, and the filter receiver may be detachably provided at the upper portion of the coffee receiving container by a third detachable portion.

The water container, the coffee powder container, the filter receiver, and the coffee receiving container may be connected to each other to have an elongated cylindrical shape which has entirely the same outer diameter.

In the coffee powder container, both the upper and lower ends thereof may be opened.

The drain portions of the water container may have a shape to protrude downward from the lower surface of the water container.

The draining portion may have an inner diameter which is decreased downward from the inner bottom surface of the water container and may be penetrated.

The coffee drip-brewer according to the embodiment of the present invention described above may further include a lid that is detachably provided on an upper opening portion of the water container, and the lid, the water container, the coffee powder container, the filter receiver, and the coffee receiving container may be connected to each other to have an elongated cylindrical shape which has entirely the same outer diameter.

The first detachable portion may include a first insertion portion forming a lower portion of the water container and having an outer diameter smaller than the outer diameter of the water container; and a first insertion guide portion forming an inner circumferential surface of the upper portion of the coffee powder container and inserted with the first insertion portion to come into contact with an outer circumferential surface of the first insertion portion.

The first detachable portion may further include a first leakage prevention member provided between the first insertion portion and the first insertion guide portion to prevent the water leakage.

The first detachable portion may further include a first male screw provided on the first insertion portion; and a first female screw provided on the first insertion guide portion to be fastened to the first male screw.

The second detachable portion may include a second insertion portion forming the lower portion of the coffee powder container and having an outer diameter smaller than the outer diameter of the coffee powder container; and a second insertion guide portion forming an inner circumferential surface of the filter receiver and inserted with the second insertion portion to come into contact with an outer circumferential surface of the second insertion portion.

The second detachable portion may further include a second leakage prevention member provided between the second insertion portion and the second insertion guide portion to prevent the water leakage.

The second detachable portion may further include a second male screw provided on the second insertion portion; and a second female screw provided on the second insertion guide portion to be fastened to the second male screw.

The third detachable portion may include a third insertion portion forming a part of an outer circumference of the filter receiver and having an outer diameter smaller than the outer diameter of the filter receiver; and a third insertion guide portion forming an inner circumferential surface of the upper portion of the coffee receiving container and inserted with the third insertion portion to come into contact with an outer circumferential surface of the third insertion portion.

The third detachable portion may further include a third leakage prevention member provided between the third insertion portion and the third insertion guide portion to prevent the water leakage.

The third detachable portion may further include a third male screw provided on the third insertion portion; and a third female screw provided on the third insertion guide portion to be fastened to the third male screw.

The coffee drip-brewer according to the embodiment of the present invention described above may further include a container holder configured to hold the water container, the coffee powder container, and the coffee receiving container to be spaced apart from each other in a vertical direction while being detached from each other.

The container holder may include an upper cradle for holding the water container; an intermediate cradle for holding the coffee powder container; a lower cradle for holding the coffee receiving container; and a stand for supporting the upper cradle, the intermediate cradle, and the lower cradle.

The upper cradle and the intermediate cradle may be provided on the stand to be adjustable with upper and lower heights.

### Advantageous Effects

As described above, the coffee drip-brewer according to the embodiment of the present invention may have the following effects.

According to the embodiment of the present invention, there is provided a technical configuration in which the coffee drip-brewer for extracting coffee by pouring water into coffer powder includes the water container, the coffee powder container, and the coffee receiving container, the coffee powder container is detachably provided at the lower portion of the water container, and the coffee receiving container is detachably provided at the lower portion of the coffee powder container. Therefore, the water container, the coffee powder container, and the coffee receiving container are connected to each other to be easily carried in a bag or the like. When a user wants to drink coffee while carrying, the user separates the coffee powder container, adds the coffee powder in the coffee powder container, connects the containers to each other again, and then pours the water into the water container to extract drip coffee, thereby enjoying the drip coffee anywhere while carrying the drip-brewer in a bag or the like. Furthermore, when the water container, the coffee powder container, and the coffee receiving container are separated from each other, washing is also easy, and thus, it is also advantageous for hygiene management.

Further, according to the embodiment of the present invention, there is provided a technical configuration in which the coffee powder container includes a filter receiver and a coffee powder container which are detachable from each other. Therefore, when the filter receiver and the coffee powder container are separated from each other, the filter receiver and the coffee powder container may be easily washed, and a filter (a filter for filtering the coffee powder while the coffee is extracted) in the filter receiver may be easily replaced by separation, so that a more hygienic use may be possible.

Further, according to the embodiment of the present invention, there is provided a technical configuration in which the water container, the coffee powder container, the filter receiver, and the coffee receiving container are connected to each other to have an elongated cylindrical shape which has entirely the same outer diameter. Therefore, the coffee drip-brewer of the present invention may be implemented in a tumbler form of which a circumference vertically falls to minimize a volume occupied by the drip-brewer when carrying the drip-brewer in a bag or the like and may be placed on a table like a general tumbler even in use to be used freely.

Further, according to the embodiment of the present invention, there is provided a technical configuration in which the drain portions of the water container have a shape protruding downward from the lower surface of the water container. Therefore, the water dropping through the drain portions may be dropped directly under the drain portions without moving along the lower surface of the water container to accurately maintain a drop point of the water. When a plurality of drain portions is provided at regular intervals, water may be evenly dropped down while the intervals are accurately maintained, so that the dropped water may pass through the coffee powder as uniformly as possible. For reference, when the drain portions do not protrude, the water of the drain portions arbitrarily moves along the lower surface of the water container, and as a result, there may be a problem that a relatively large amount of water is dropped to any one side.

Further, according to the embodiment of the present invention, there is provided a technical configuration in which the draining portion has an inner diameter which is decreased downward from the inner bottom surface of the water container and is penetrated. Therefore, it is possible to maintain a drop point more accurately, such as the water dropped through the drain portion may be concentrated in one dot form and dropped without spreading.

Further, according to the embodiment of the present invention, there is provided a technical configuration in which a leakage prevention member is provided at a connection portion by detaching to prevent water leakage. Therefore, it is possible to prevent the water from being leaked from the connection portion while extracting the coffee or carrying.

Further, according to the embodiment of the present invention, there is provided a technical configuration in which the container holder is further included. Therefore, the container holder may hold the water container, the coffee powder container, and the coffee receiving container to be spaced apart from each other in a vertical direction while being detached from each other, thereby enjoying the aroma of coffee while extracting, inspiring an atmosphere by the aroma of the coffee, and determining an extraction ending point of the coffee while seeing the coffee to be extracted with naked eyes.

Further, according to the embodiment of the present invention, there is provided a technical configuration in which the upper cradle and the intermediate cradle are provided on the stand to be adjustable with upper and lower heights. Therefore, a depth at which the dropped water penetrates into the coffee powder varies by adjusting the height of the water dropped from the water container, thereby varying the taste of the coffee. For example, when the height of the water container is increased, the water dropped from the water container may penetrate deeper into the coffee powder.

### DESCRIPTION OF DRAWINGS

FIG. 1 is a perspective view schematically illustrating a coffee drip-brewer of the present invention.

FIG. 2 is a diagram of the coffee drip-brewer of FIG. 1 taken along a line II_II.

FIG. 3 is a diagram schematically illustrating a separated state of the coffee drip-brewer of FIG. 1.

FIG. 4 is a diagram of enlarging a part “A” of the coffee drip-brewer of FIG. 2.

FIG. 5 is a diagram illustrating a lower surface of a water container of the coffee drip-brewer of FIG. 3.

FIG. 6 is a diagram schematically illustrating a lower surface of a filter receiver of the coffee drip-brewer of FIG. 3.

FIG. 7 is a diagram schematically illustrating a container holder of holding the coffee drip-brewer of FIG. 3.

FIG. 8 is a diagram schematically illustrating a state in which the coffee drip-brewer of FIG. 3 is held on the container holder.

### MODES FOR THE INVENTION

Hereinafter, an embodiment of the present invention will be described more fully hereinafter with reference to the accompanying drawings so as to be easily implemented by those skilled in the art. As those skilled in the art would realize, the described embodiments may be modified in various different ways, all without departing from the spirit or scope of the present invention.

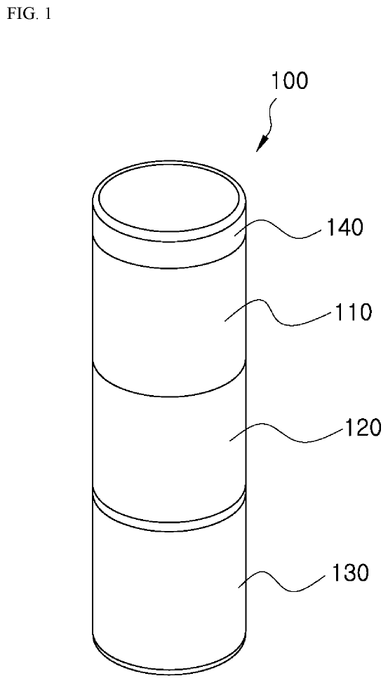

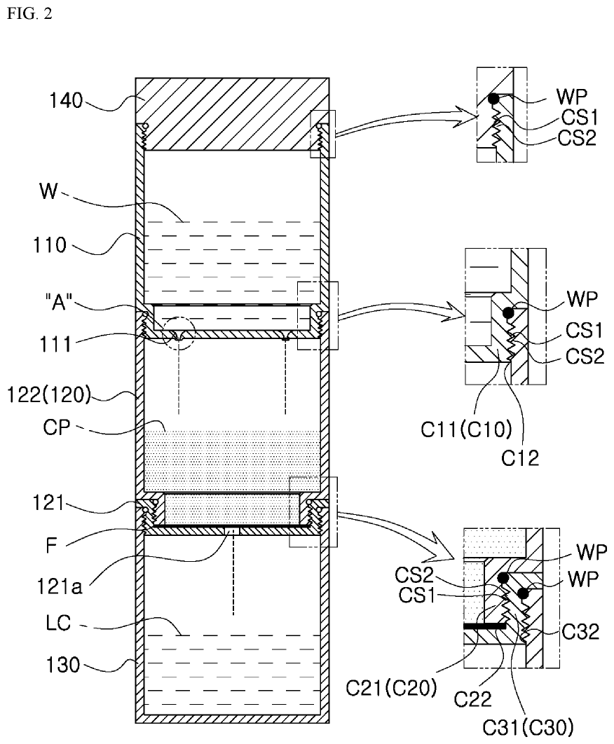

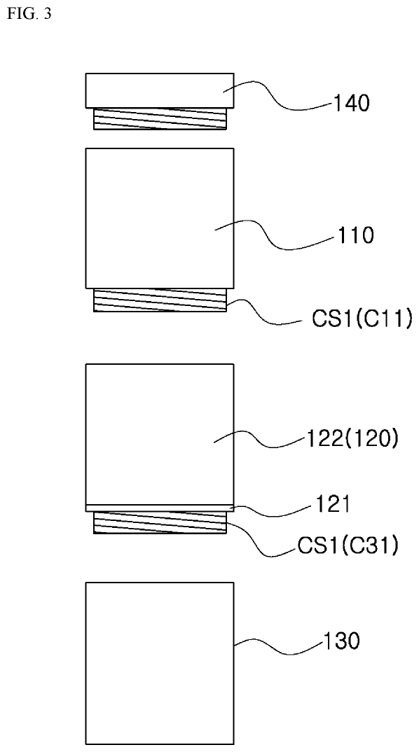

FIG. 1 is a perspective view schematically illustrating a coffee drip-brewer of the present invention, FIG. 2 is a diagram of the coffee drip-brewer of FIG. 1 taken along a line II_II, and FIG. 3 is a diagram schematically illustrating a separated state of the coffee drip-brewer of FIG. 1.

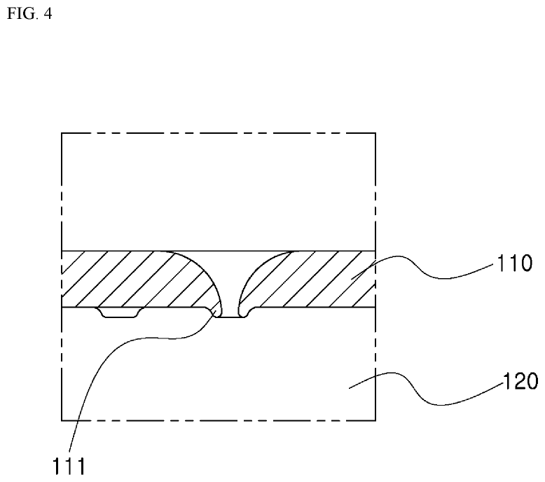

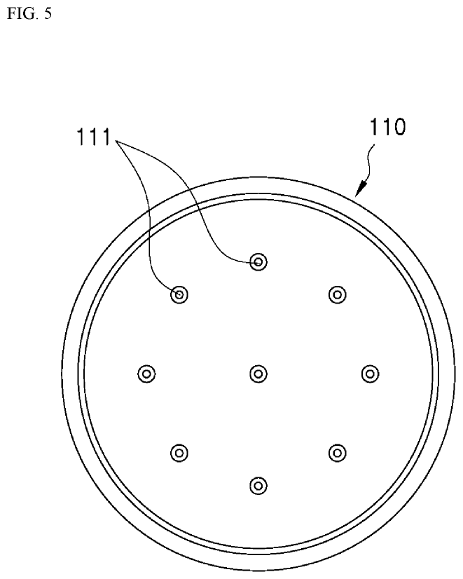

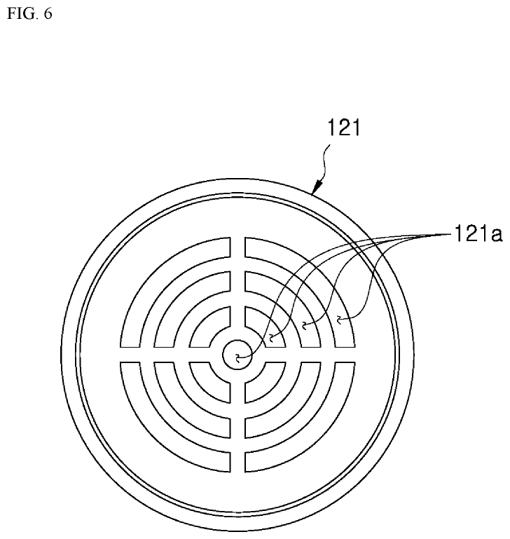

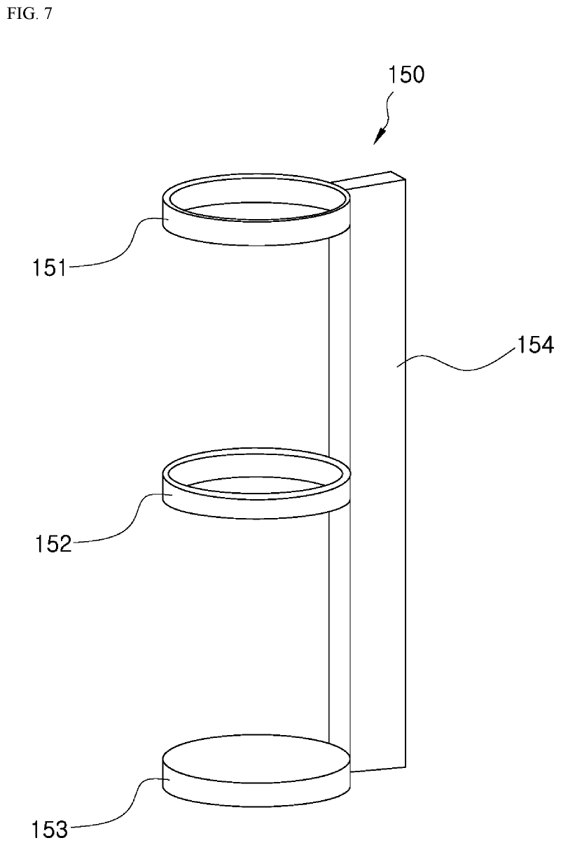

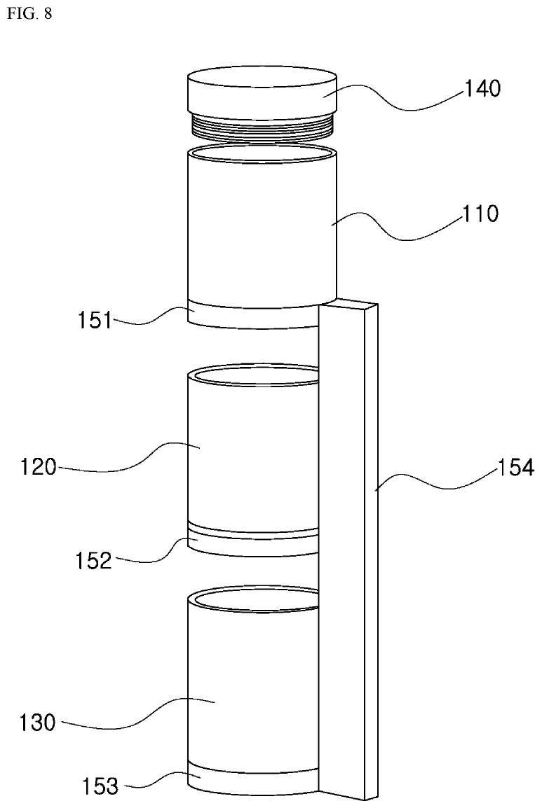

FIG. 4 is a diagram of enlarging a part “A” of the coffee drip-brewer of FIG. 2, FIG. 5 is a diagram illustrating a lower surface of a water container of the coffee drip-brewer of FIG. 3, and FIG. 6 is a diagram schematically illustrating a lower surface of a filter receiver of the coffee drip-brewer of FIG. 3. FIG. 7 is a diagram schematically illustrating a container holder of holding the coffee drip-brewer of FIG. 3, and FIG. 8 is a diagram schematically illustrating a state in which the coffee drip-brewer of FIG. 3 is held on the container holder.

According to an embodiment of the present invention, a coffee drip-brewer 100, as illustrated in FIGS. 1 to 8, as a coffee drip-brewer for extracting coffee by pouring water W into coffer powder CP, includes a water container 110, a coffee powder container 120, and a coffee receiving container 130. Hereinafter, continuously referring to FIGS. 1 to 8, each component will be described in detail.

The water container 110 is a component for containing the water W as illustrated in FIG. 2. The water container 110 may have one or more drain portions 111 formed at the lower end thereof, as illustrated in FIGS. 2, 4 and 5. For example, a user may use the coffee drip-brewer by pouring hot water contained in a vacuum flask or the like into the water container 110, and also use the coffee drip-brewer by pouring cold water that can be easily obtained in the vicinity.

Further, the water container 110 may have a hollow cylindrical shape, as illustrated in FIGS. 1, 2 and 8, have a structure of which an upper portion is opened and a lower portion is closed, and have one or more drain portions 111 formed on the closed lower portion thereof.

The coffee powder container 120 is a component for containing the coffee powder CP as illustrated in FIG. 2. Such a coffee powder container 120 may be detachably provided at the lower portion of the water container 110, as illustrated in FIGS. 2 and 3, and may form a moving path of the water drained through the drain portions 111. Further, the coffee powder container 120 may have a hollow cylindrical shape, as illustrated in FIGS. 1, 2 and 8.

The coffee receiving container 130 is a component for receiving coffee passing through the coffee powder CP, that is, extracted coffee LC, as illustrated in FIG. 2. The coffee receiving container 130 may be detachably provided at the lower portion of the coffee powder container 120, as illustrated in FIGS. 2 and 3, and may receive the extracted coffee LC passing through the coffee powder CP.

Further, the coffee receiving container 130 may have a hollow cylindrical shape, as illustrated in FIGS. 1, 2 and 8, and may have a structure of which an upper portion is opened and a lower portion is closed.

Therefore, since the above components are provided, the water container 110, the coffee powder container 120, and the coffee receiving container 130 are connected to each other to be easily carried in a bag or the like. When the user wants to drink coffee while carrying, the user separates the coffee powder container 120, adds the coffee powder CP in the coffee powder container 120, connects the containers to each other again, and then pours the water W into the water container 110 to extract drip coffee, thereby enjoying the drip coffee anywhere while carrying the drip-brewer in a bag or the like. Furthermore, when the water container 110, the coffee powder container 120, and the coffee receiving container 130 are separated from each other, washing is also easy, and thus, it is also advantageous for hygiene management.

Hereinafter, the coffee powder container 120 will be described in more detail with reference to FIGS. 2, 3, and 6.

The coffee powder container 120 may include a filter receiver 121 and a coffee powder container 122, as illustrated in FIG. 2.

The filter receiver 121 may be detachably provided at the upper portion of the coffee receiving container 130, as illustrated in FIGS. 2, 3 and 6, may be seated with a filter F for filtering the coffee powder CP while the coffee is extracted, and have one or more through holes 121a for finally discharging the extracted coffee LC passing through the coffee powder CP.

The coffee powder container 122 may be detachably provided at the upper portion of the filter receiver 121 as illustrated in FIG. 2 and may contain the coffee powder CP with the filter receiver 121. Further, the coffee powder container 122 may have a structure in which both the upper and lower ends are opened, as illustrated in FIG. 2. For reference, since the filter receiver 121 is mounted on the opened lower end of the coffee powder container 122, the coffee powder CP may be maintained to be contained in the coffee powder container 122.

Therefore, when the filter receiver 121 and the coffee powder container 122 are separated from each other, the filter receiver 121 and the coffee powder container 122 may be easily washed, and the filter F (a filter for filtering the coffee powder while the coffee is extracted) in the filter receiver 121 may be easily replaced by separation, so that a more hygienic use may be possible.

Hereinafter, the drain portions 111 of the water container 110 will be described in more detail with reference to FIGS. 2, 4, and 5.

The drain portions 111 of the water container 110 may have a shape to protrude downward from the lower surface of the water container 110, as illustrated in FIGS. 2 and 4. Therefore, the water dropping through the drain portions 111 may be dropped directly under the drain portions 111 without moving along the lower surface of the water container 110 to accurately maintain a drop point of the water. When a plurality of drain portions 111 is provided at regular intervals (see FIG. 5), water may be evenly dropped down while the intervals are accurately maintained, so that the dropped water may pass through the coffee powder CP as uniformly as possible. For reference, unlike this, although not illustrated, when the drain portions do not protrude, the water of the drain portions arbitrarily moves along the lower surface of the water container, and as a result, there may be a problem that a relatively large amount of water is dropped to any one side.

As illustrated in FIGS. 2 and 4, the draining portion 111 may have an inner diameter which is decreased downward from the inner bottom surface of the water container 110 and may be penetrated. Therefore, it is possible to maintain a drop point more accurately, such as the water dropped through the drain portions 111 may be concentrated in one dot form and dropped without spreading.

On the other hand, as illustrated in FIGS. 1 and 2, the water container 110, the coffee powder container 122, the filter receiver 121, and the coffee receiving container 130 are connected to each other to have an elongated cylindrical shape which has entirely the same outer diameter.

Accordingly, the coffee drip-brewer 100 of the present invention may be implemented in a tumbler form of which a circumference vertically falls to minimize a volume occupied by the drip-brewer when carrying in a bag or the like and may be placed on a table like a general tumbler even in use to be used freely.

In addition, the coffee drip-brewer 100 according to an embodiment of the present invention may further include a lid 140 that is detachably provided on an upper opening portion of the water container 110, as illustrated in FIGS. 1 to 3.

Furthermore, even in the case where the lid 140 is further included, as illustrated in FIGS. 1 and 2, the lid 140, the water container 110, the coffee powder container 122, the filter receiver 121, and the coffee receiving container 130 are connected to each other to have an elongated cylindrical shape which has entirely the same outer diameter.

Hereinafter, the detachable structure will be described in more detail with reference to FIGS. 2 and 3.

A lower portion of the water container 110 may be detachably provided at the upper portion of the coffee powder container 122 by a first detachable portion C10, a lower portion of the coffee powder container 122 may be detachably provided on the filter receiver 121 by a second detachable portion C20, and the filter receiver 121 may be detachably provided at the upper portion of the coffee receiving container 130 by a third detachable portion C30.

For example, the first detachable portion C10 may include a first insertion portion C11 and a first insertion guide portion C12, as illustrated in FIG. 2. The first insertion portion C11 may form the lower portion of the water container 110 and may have an outer diameter smaller than the outer diameter of the elongated cylindrical shape described above, and the first insertion guide portion C12 may form an inner circumferential surface of the upper portion of the coffee powder container 122 and may be inserted with the first insertion portion C11 to come into contact with an outer circumferential surface of the first insertion portion C11.

Further, the second detachable portion C20 may include a second insertion portion C21 and a second insertion guide portion C22, as illustrated in FIG. 2. The second insertion portion C21 may form the lower portion of the coffee powder container 122 and have an outer diameter smaller than the outer diameter of the elongated cylindrical shape described above, and the second insertion guide portion C22 may form an inner circumferential surface of the filter receiver 121 and may be inserted with the second insertion portion C21 to come into contact with an outer circumferential surface of the second insertion portion C21.

Further, the third detachable portion C30 may include a third insertion portion C31 and a third insertion guide portion C32, as illustrated in FIG. 2. The third insertion portion C31 may form a part of an outer circumference of the filter receiver 121 and may have an outer diameter smaller than the outer diameter of the elongated cylindrical shape described above, and the third insertion guide portion C32 may form an inner circumferential surface of the upper portion of the coffee receiving container 130 and may be inserted with the third insertion portion C31 to come into contact with an outer circumferential surface of the third insertion portion C31.

Furthermore, each of the first, second and third detachable portions C10, C20, and C30, as illustrated in FIG. 2, may further include a leakage prevention member WP provided between the corresponding insertion portion (see C11) and the corresponding insertion guide portion (see C12) to prevent the water leakage. Therefore, it is possible to prevent the water from being leaked from the connection portion while extracting the coffee or carrying.

Further, each of the first, second and third detachable portions C10, C20, and C30, as illustrated in FIG. 2, may further include a male screw CS1 and a female screw CS2. The male screw CS1 may be provided on the corresponding insertion portion (see C11) and the female screw CS2 may be provided on the corresponding insertion guide portion (see C12) to be fastened to the male screw CS1.

In addition, the coffee drip-brewer 100 according to an embodiment of the present invention may further include a container holder 150, as illustrated in FIGS. 7 to 8. The container holder 150 may hold the water container 110, the coffee powder container 120, and the coffee receiving container 130 to be spaced apart from each other in a vertical direction while being detached from each other.

For example, the container holder 150 may include an upper cradle 151, an intermediate cradle 152, a lower cradle 153, and a stand 154, as illustrated in FIGS. 7 and 8. The upper cradle 151 may hold the water container 110, the intermediate cradle 152 may hold the coffee powder container 120, and the lower cradle 153 may hold the coffee receiving container 130. In addition, the stand 154 may support the upper cradle 151, the intermediate cradle 152, and the lower cradle 153.

Accordingly, the container holder 150 may hold the water container 110, the coffee powder container 120, and the coffee receiving container 130 to be spaced apart from each other in a vertical direction while being detached from each other, thereby enjoying the aroma of coffee while extracting, inspiring an atmosphere by the aroma of the coffee, and determining an extraction ending point of the coffee while seeing the coffee to be extracted with naked eyes.

Further, although not illustrated, the upper cradle 151 and the intermediate cradle 152 may be provided on the stand 154 to be adjustable with upper and lower heights. For example, the upper cradle 151 and the intermediate cradle 152 vertically slide on the stand 154 with a rail structure (not illustrated) and may be implemented so that the height is adjusted with a structure to be fastened with a fixing bolt (not illustrated) (e.g., a butterfly bolt, etc.) at a desired height.

Therefore, a depth at which the dropped water penetrates into the coffee powder CP varies by adjusting the height of the water dropped from the water container 110, thereby varying the taste of the coffee. For example, when the height of the water container 110 is increased, the water dropped from the water container 110 may penetrate deeper into the coffee powder CP.

While the present invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

[Explanation of Reference Numerals and Symbols]

| | | | |
|---|---|---|---|
| 100: | Coffee drip-brewer | W: | Water |
| CP: | Coffee powder | LC: | Extracted coffee |
| 110: | Water container | 111: | Drain portion |
| 120: | Coffee powder container | 121: | Filter receiver |
| 121a: | Through hole | F: | Filter |
| 122: | Coffee powder container | 130: | Coffee receiving container |
| C10: | First detachable portion | C11: | First insertion portion |
| C12: | First insertion guide portion | WP: | Leakage prevention member |
| CS1: | Male screw | CS2: | Female screw |
| C20: | Second detachable portion | C21: | Second insertion portion |
| C22: | Second insertion guide portion | C30: | Third detachable portion |
| C31: | Third insertion portion | C32: | Third insertion guide portion |
| 140: | Lid | 150: | Container holder |
| 151: | Upper cradle | 152: | Intermediate cradle |
| 153: | Lower cradle | 154: | Stand |

1. A coffee drip-brewer comprising, as a coffee drip-brewer for extracting coffee by pouring water into coffee powder:
a water container configured to contain the water and have one or more drain portions formed on a lower end thereof;
a coffee powder container provided detachably at a lower portion of the water container and configured to contain the coffee powder and form a moving path of the water drained by the drain portions; and
a coffee receiving container provided detachably at a lower portion of the coffee powder container and configured to pass through the coffee powder and receive the extracted coffee.

2. The coffee drip-brewer of claim 1, wherein the coffee powder container comprises:
a filter receiver provided detachably at an upper portion of the coffee receiving container, seated with a filter for filtering the coffee powder while the coffee is extracted, and having one or more through holes; and
a coffee powder container provided detachably at an upper portion of the filter receiver and containing the coffee powder with the filter receiver.

3. The coffee drip-brewer of claim 1, further comprising:
a container holder configured to hold the water container, the coffee powder container, and the coffee receiving container to be spaced apart from each other in a vertical direction while being detached from each other.
